(19) United States
(12) Patent Application Publication
(10) Pub. No.: US 2024/0020608 A1
(43) Pub. Date: Jan. 18, 2024

(54) SOFTWARE-AS-A-SERVICE INNOVATION AUTOMATION PROCESS AND SYSTEM

(71) Applicant: InnovationForce Inc., Durham, NC (US)

(72) Inventors: Ivan Aguilar, Phoenix, AZ (US); Kim Getgen, Little River, SC (US); Linda Hill, Brookline, MA (US); Cheryl Whaley, New York, NY (US)

(21) Appl. No.: 18/213,798

(22) Filed: Jun. 23, 2023

Related U.S. Application Data
(60) Provisional application No. 63/354,934, filed on Jun. 23, 2022.

(51) Int. Cl. G06Q 10/0633; G06Q 10/0631

(52) U.S. Cl. CPC G06Q 10/0633; G06Q 10/06312

(57) ABSTRACT

A network-accessible, on-line platform for innovation management, which provides organizations with the technological ability to simplify complex innovation by establishing connections among individual nodes in an innovation network and automate workflows among those nodes using artificial intelligence and/or machine learning. The platform learns from human-designed innovation networks and contextual information to develop AI models of successful innovation strategies and designs new workflows and optimizes existing workflows for rapid innovation.

### CROSS-REFERENCE TO RELATED APPLICATIONS

This application claims the benefit of U.S. Prov. Pat. App. Ser. No. 63/354,934, filed Jun. 23, 2022, the entire disclosure of which is incorporated herein by reference.

### BACKGROUND OF THE INVENTION

### Field of the Invention

This disclosure generally relates to systems and processes for automating innovation through the use of Artificial Intelligence/Machine Learning. Specifically, there are disclosed systems and processes for automating innovation through the use of specific use case data collection, metrics, and artificial intelligence/machine learning, at least in some embodiments.

### Description of the Related Art

Innovation is the process of creating and implementing new ideas, methods, products, or services resulting in improvements or advancements applicable to a particular field or industry. Innovation inherently means change: transforming existing concepts or practices into a new, more valuable form or combination. Innovation is widely associated with technology and scientific fields, but is applicable to any type of rethinking or processes, systems, and concepts. Generally requiring the strategic and thoughtful application of creativity, problem-solving, and strategic thinking, innovation involves identifying and capitalizing upon opportunities for improvement through novel solutions.

Although innovation is widely valued, it is often elusive and difficult to achieve, particularly in organizational settings. Often, organizations have substantial structural resistance to change, particularly where employees have become accustomed to long-established processes and ways of working. Employees may fear change or perceive it as a threat to job security, or simply experience the abstract and generalized fear of the unknown. Additionally, organizations with risk-averse cultures may openly or implicitly discourage employees from innovation. Some organizations highly stigmatize failure, which can further inhibit receptiveness to innovation.

Other factors may also inhibit innovation. Limited resources, such as time, funding, talent, and expertise, can hinder innovative efforts, and organizations may be overly focused on short-term goals and struggle to dedicate the resources necessary for innovative ideas that may have only a speculative chance of a long-term return on investment. Also, organizations with rigid hierarchical structures, highly towered or siloed internal business units or departments, and other structural barriers may impede collaboration, thereby hindering or preventing the free exchange of ideas.

Innovation also requires some organizational rigor and leadership. Without a clear strategy aligned with the organization's overall objectives and structural capabilities, innovation initiatives often lack direction and focus, and never get off the ground. Insufficient support and leadership from top management, as well as a lack of diversity and inclusion, further contribute to the challenges of fostering innovation.

Overcoming these obstacles requires proactive efforts from organizational leaders to foster an innovation-friendly culture, provide resources and support, encourage risk-taking and learning from failure, and establish clear strategies and processes to nurture and implement innovative ideas.

Even organizations that have mastered the art of innovation struggle to scale their efforts. As the number of distinct actors involved the innovation force of an organization increases, innovation becomes increasingly difficult to manage, and scaling becomes increasingly difficult to achieve. The push-pull of the many challenges to establishing and maintaining an innovation environment multiply exponentially with growth, and there is a need to reduce the number of workhours per person to manage the process while also achieving comparable outcomes. Technology has long been used to organize human collaboration, but these technologies tend to introduce as many problems as they address. Existing productivity and collaboration tools do not support innovation management, but rather merely provide convenient ways of communicating and synchronizing information, and also require that all participants learn and use the same interface and organize their efforts based on the file formats, data structures, and communication paradigms implemented in those programs. This introduces new technological barriers to rapid innovation, as it imposes workflow homogenization and lacks adequate data access and management.

### SUMMARY OF THE INVENTION

The following is a summary of the invention to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is one or more non-transitory computer-readable storage media storing one or more programs, the one or more programs comprising instructions, which when executed by one or more processors of one or more server computers, cause the one or more server computers to: receive, via a telecommunication network, a plurality of requests to create an innovation node for an associated resource, each of the requests comprising resource characteristic data for the associated resource; create, for each request of the plurality of received requests, profile data for the associated resource, the profile data comprising at least some of the resource characteristic data for the associated resource; receive, via a graphical user interface rendered to a client computer via the telecommunication network, instructions to create a first innovation process workflow associated with an innovation context identifier; create the innovation process workflow in accordance with the received instructions, the innovation process workflow comprising a plurality of steps, each step of the plurality of steps comprising at least one task assigned to at least one innovation node in the plurality of innovation nodes; receive, via the telecommunications network, a plurality of datagrams each indicating that at least one of the tasks is complete, the plurality of datagrams collectively indicating that all of the tasks are complete; receive, via the telecommunications network, evaluation data for the completed innovation process workflow; generate a training data set for an artificial intelligence model based at least in part on the evaluation data and the completed innovation process workflow; and using the training data set, train at least one artificial intelligence model to generate innovation process workflows for the innovation context.

In an embodiment, the resource characteristic data comprises one or more characteristics selected from the group consisting of: type, privilege, credentials, license, cost, qualifications, skills, industry/field, and availability.

In a further embodiment, the associated resource is selected from the group consisting of: a person, an organization, a computer system, a data source, and a process.

In a still further embodiment, a first innovation node of the plurality of innovation nodes comprises an administrative node.

In a still further embodiment, the created innovation process workflow further comprises, for at least some steps in the plurality of steps, an identification of at least one input to the step and an identification of at least one output from the step.

In a still further embodiment, the evaluation data is received from a client computer associated with the administrative node.

In a still further embodiment, the instructions, when executed by the one or more processors of the one or more server computers, further cause the one or more the computers to: receive user input data from a client computer via the telecommunications network, the user input data comprising information about a desired innovation process workflow; and create, using the trained at least one artificial intelligence model, an innovation process workflow based on the received user input data.

In a still further embodiment, the instructions, when executed by the one or more processors of the one or more computers, further cause the one or more computers to: predict, using the trained at least one artificial intelligence model, a cost budget for the innovation process workflow created using the using the trained at least one artificial intelligence model.

In a still further embodiment, the instructions, when executed by the one or more processors of the one or more computers, further cause the one or more computers to optimize an innovation process workflow using the training at least one artificial intelligence model.

In a still further embodiment, the optimization comprises reassigning a first task to a different innovation node.

Also described herein, among other things, is a method comprising: receiving, via a telecommunication network, a plurality of requests to create an innovation node for an associated resource, each of the requests comprising resource characteristic data for the associated resource; creating, for each request of the plurality of received requests, profile data for the associated resource, the profile data comprising at least some of the resource characteristic data for the associated resource; receiving, via a graphical user interface rendered to a client computer via the telecommunication network, instructions to create a first innovation process workflow associated with an innovation context identifier; creating the innovation process workflow in accordance with the received instructions, the innovation process workflow comprising a plurality of steps, each step of the plurality of steps comprising at least one task assigned to at least one innovation node in the plurality of innovation nodes; receiving, via the telecommunications network, a plurality of datagrams each indicating that at least one of the tasks is complete, the plurality of datagrams collectively indicating that all of the tasks are complete; receiving, via the telecommunications network, evaluation data for the completed innovation process workflow; generating a training data set for an artificial intelligence model based at least in part on the evaluation data and the completed innovation process workflow; and using the training data set, training at least one artificial intelligence model to generate innovation process workflows for the innovation context.

In an embodiment, the resource characteristic data comprises one or more characteristics selected from the group consisting of: type, privilege, credentials, license, cost, qualifications, skills, industry/field, and availability.

In another embodiment, the associated resource is selected from the group consisting of: a person, an organization, a computer system, a data source, and a process.

In a further embodiment, a first innovation node of the plurality of innovation nodes comprises an administrative node.

In a still further embodiment, the created innovation process workflow further comprises, for at least some steps in the plurality of steps, an identification of at least one input to the step and an identification of at least one output from the step.

In a still further embodiment, the evaluation data is received from a client computer associated with the administrative node.

In a still further embodiment, the method further comprises: receiving user input data from a client computer via the telecommunications network, the user input data comprising information about a desired innovation process workflow; and creating, using the trained at least one artificial intelligence model, an innovation process workflow based on the received user input data.

In a still further embodiment, the method further comprises: predicting, using the trained at least one artificial intelligence model, a cost budget for the innovation process workflow created using the using the trained at least one artificial intelligence model.

In a still further embodiment, the method further comprises: optimizing an innovation process workflow using the training at least one artificial intelligence model.

In a still further embodiment, the optimization comprises reassigning a first task to a different innovation node.

### BRIEF DESCRIPTION OF THE DRAWINGS

FIG. 1-9 show embodiments of a graphical user interface for user interaction with a system in accordance with this disclosure.

FIG. 10 is a schematic diagram of an system in accordance with this disclosure.

FIG. 11 is a schematic diagram of an innovation network within the system of FIG. 10 in accordance with this disclosure.

FIG. 12 is a schematic diagram of a server computer in the system of FIG. 10.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

At a high level of generality, this disclosure is directed to a network-accessible, on-line platform for innovation management, which provides organizations with the technological ability to simplify complex innovation by establishing connections among individual nodes in an innovation network and automate workflows among those nodes using artificial intelligence and/or machine learning.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described herein are contemplated to use computers and computer software typically stored in a computer- or machine-readable storage medium or memory.

Program code embodied on a computer readable medium may be transmitted using any appropriate medium, including but not limited to wireless, wireline, optical fiber cable, RF, etc., or any suitable combination of the foregoing.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the terms “web,” “web site,” “web server,” “web client,” and “web browser” refer generally to computers programmed to communicate over a network using the Hypertext Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “GUI” generally refers to a graphical user interface for a computing device. The design, arrangement, components, and functions of a graphical user interface will necessarily vary from device to device depending on, among other things, screen resolution, processing power, operating system, device function or purpose, and evolving standards and tools for user interface design. One of ordinary skill in the art will understand that graphical user interfaces generally include a number of widgets, or graphical control elements, which are generally graphical components displayed or presented to the user and which are manipulable by the user through an input device to provide user input, and which may also display or present to the user information, data, or output.

The terms “artificial intelligence” and “AI” refer broadly to a discipline in computer science concerning the creation of software that performs (or appears to perform) tasks using the reasoning faculties of humans. In practice, AIs currently lack the ability to exercise true human reasoning, and are instead trained to simulate reasoning. This effect is contextual, and in most cases, narrowly confined to one, or a very small number, of well-defined tasks (such as recognizing a human face in an image). A common implementation of AI is supervised machine learning, where a model is trained by providing large sets of pre-classified inputs, each set representing different desired outputs from the AI. For example, if the AI is meant to recognize a human face, one set of inputs contains a human face in each image, and one set does not. The “AI” is a statistical engine that uses mathematics to identify and model data patterns common to one set but not the other. This process is known as “training” the AI. Once the AI is trained, new unclassified data is provided to it for analysis, and the software assesses which of the labels it has been trained on best fits the new data. Most AIs also provide a confidence level in the prediction. A human supervisor may provide feedback to the AI as to whether it was right, and this feedback may be used to refine its models further. Each discrete task that an AI is trained to perform may be referred to herein as a “model.” General-purpose AIs not trained on one specific task, notably large language models like ChatGPT, are trained in fundamentally the same way, using enormous data sets covering a broad range of topics, and such models produce output by, essentially, generatively predicting, based on the training data, what the next word in the response should be.

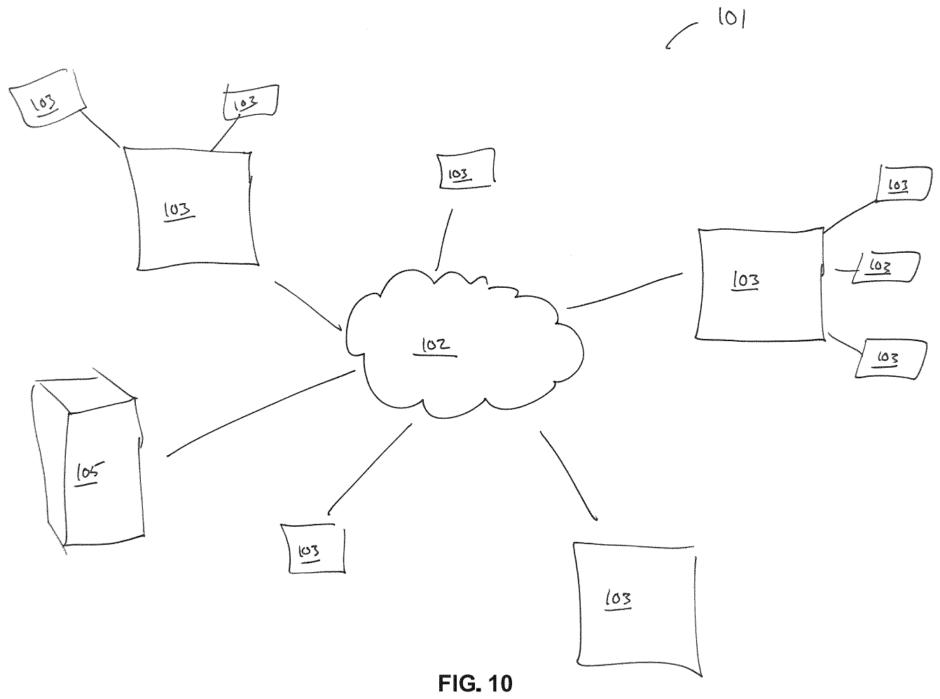

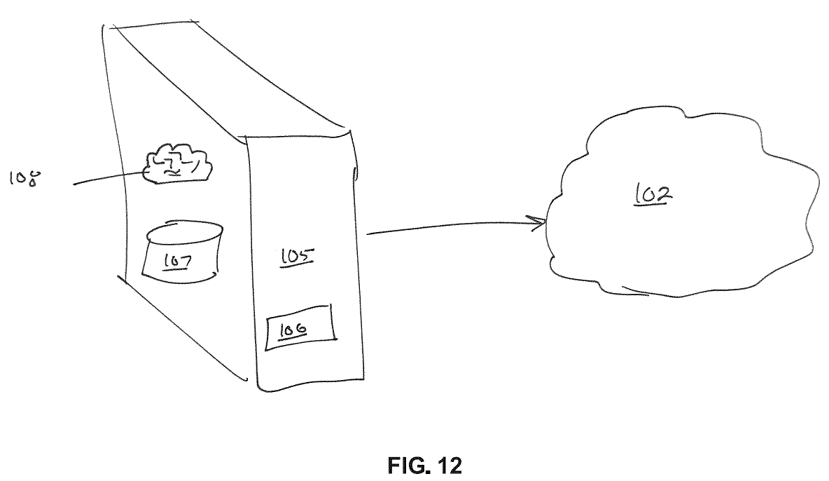

FIG. 10 depicts a system (101) for the creation of innovation networks accessible by human users through a GUI, generally implemented as an on-line platform accessed in a client-server model, such as using a web browser to access a web site. The depicted system (101) comprises a plurality of nodes (103) communicating with each other and with a server computer (105) via a telecommunications network (102), generally the public Internet. It will be understood that such a computer server (105) will normally be outfitted with a data store (107) or access thereto to manage the data and information described herein in the conventional manner. As shown in FIG. 12, the computer server (105) will generally also contain or be operatively coupled to the AI models (108) described herein. Reference herein may be made a “platform” conducting various functions or tasks. This should be understood as referring to a server software program or collection of programs (106) executed by the computer server (105) or collection of servers, and/or the associated AI models (108) working in concert to deliver the functionality described herein.

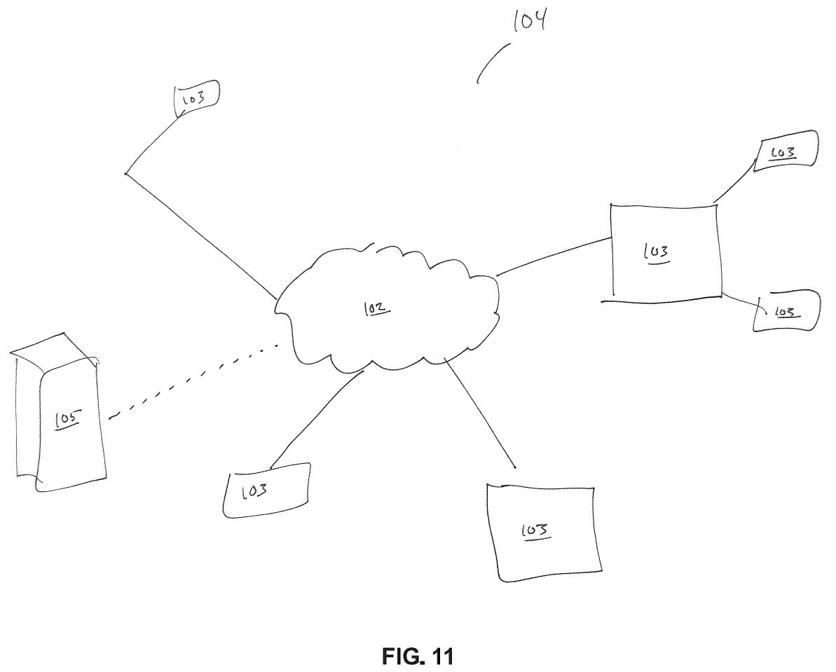

FIG. 11 depicts an innovation network (104) implemented via the depicted system (101). The depicted innovation network (104) is comprised of a plurality of innovation nodes (103), each of which represents a discrete participant in the innovation network. While this participant will generally be a person, it may also comprise an organization (which may be in turn be comprised of sub-nodes), a data source or system, a process, or other elements of an innovation ecosystem. The participants in an innovation network may be nodes (103) associated with a single enterprise, or a plurality of enterprises. One or more nodes (103) may be designated as administrative or managerial nodes, and may have elevated authority to use features and functions of the platform not available to regular or standard nodes (103).

Generally, the user associated with an administrative node manipulates a GUI to design and create workflows among some or all of the nodes (103) to facilitate an innovative process. The workflows generally involve the identification of inputs and outputs for each step of the workflow, and where the inputs are received from, and where the outputs are sent, and which nodes (103) are responsible for each task in the workflow step. As the users or elements associated with each node (103) complete tasks, data collection is performed for later analytics. In an embodiment, workflows may be further broken down into microtasks, which may, like an element of a workflow step, be assigned to a specific node or nodes, for completion.

Each workflow may be associated with an innovation context, such as but not limited to a product, process, industry, or field. As the workflows are utilized, successes and failures will emerge (e.g., based on the assessments provided by users, such as those associated with administrative nodes), and this information may be used to train one or more AI models (108) to recommend or predict optimizations to the workflow and/or innovation network which may accelerate the rate of innovation in the network, and/or increase the chances of future successful outcomes. This is done by the use of statistical analysis, machine learning, and other AI models (108) to identify trends in successful projects and apply those insights to other workflows or networks, or to design or recommend entirely new networks or workflows from scratch. In an embodiment, various networks (104) may also be globally connected across multiple enterprises into innovation “labs,” where different networks of nodes (103) may independently implement various workflows to provide experimental data as to which workflows are the fastest and most successful, and to provide data for the AI engine (108) to identify the characteristics of highly successful networks (104) and workflows.

In an embodiment, the platform may use one or more AI models (108) to dynamically modify or update a workflow to optimize it in-progress. For example, user nodes (103) may comprise data about user skills, competencies, and availability (e.g., a calendar), and the platform may be programmed to identify stalled elements of a workflow that are long overdue, identify another node (103) with the same or comparable capabilities as to the node (103) to which the step or microtask is currently assigned, and automatically reassign that step or task to another available node (103) indicated in the calendar data as having immediate workflow throughput to work on the task.

This individual may or may not be in the same organization as the original. In this fashion, the platform is able to automatically coordinate activities amongst different pluralities of nodes (103) who have no direct communication or shared coordination systems with each other, and who may not even have knowledge of each other's skills and competencies. Indeed, for some enterprises, this information is considered confidential, and there may be commercial or business reasons why one enterprise wishes to participate in a collaborative innovation process but does not wish to make the identification or characteristics of its resources known to others. By using the workflow and AI models (108) described herein, activities may be coordinated across multiple such enterprises while maintaining anonymity, privacy, and/or secrecy as may be required, such as by policy or law.

Through machine learning, the AI models (108) will over time develop the ability to determine the optimal time for reassigning tasks. The success and failure rates of such reassignments may be provided back to the platform as further training data. For example, if the platform reassigns a task of a particular type that is overdue by a particular amount of time, and such reassignments at such times frequently do not result in the task being promptly completed, the AI (108) machine may learn that this is not an optimal time to reassign this type of task, or that this type of task should rarely or never be reassigned. It may be the task in question requires such individualized knowledge of a particular organization that the skill set does not travel across organization boundaries, and, thus, reassigning the task is ineffective to get it done sooner.

The AI (108) need not understand why such assignments are ineffective, it need only learn that they are, and adjust its recommendations and optimizations accordingly. Similarly, by way of example, the platform may determine that certain tasks are almost always completed approximately 3 weeks after reassignment. It stands to reason that this task simply takes 3 weeks to complete, and the platform may develop a model to refrain from reassigning that particular type of task until the original assignee has had the task for at least 3 weeks.

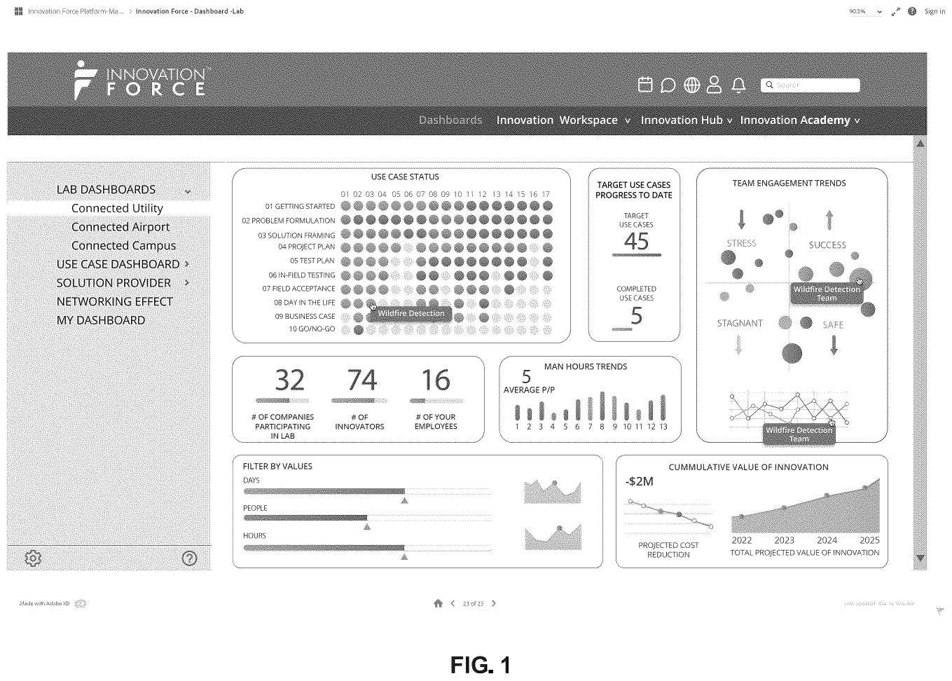

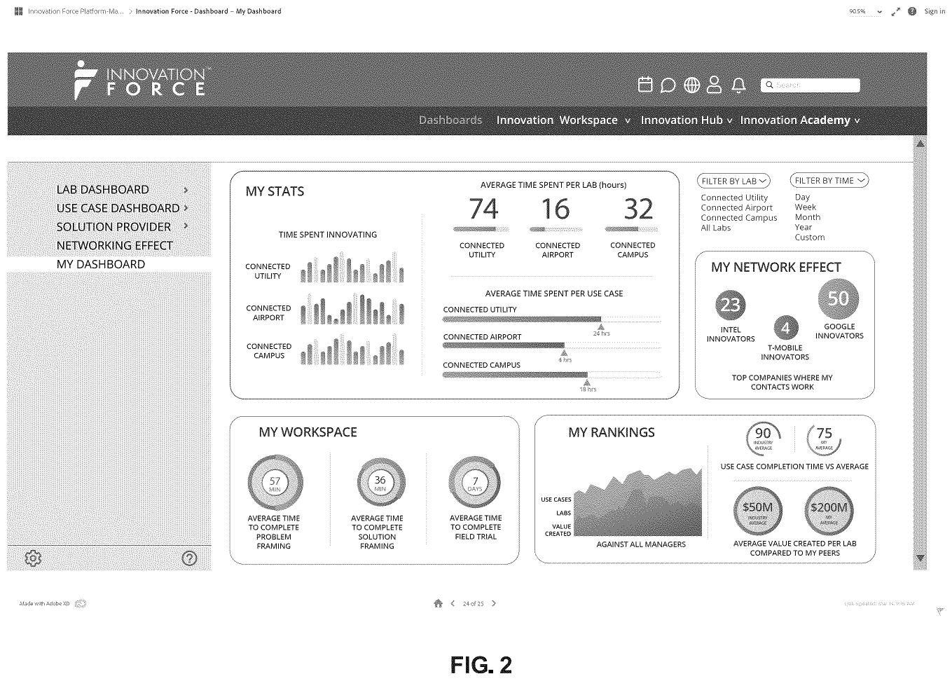

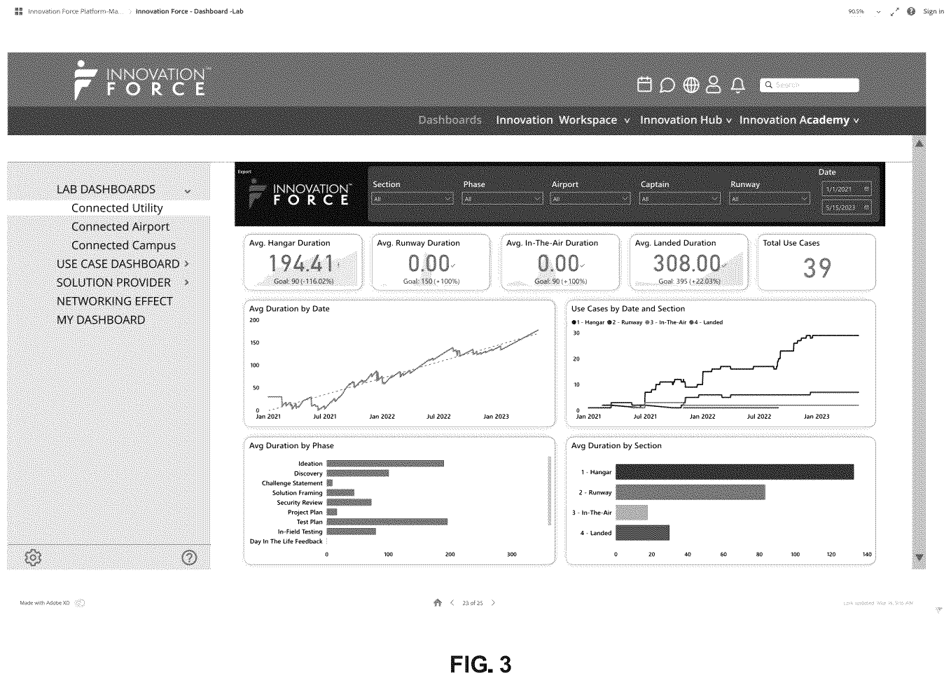

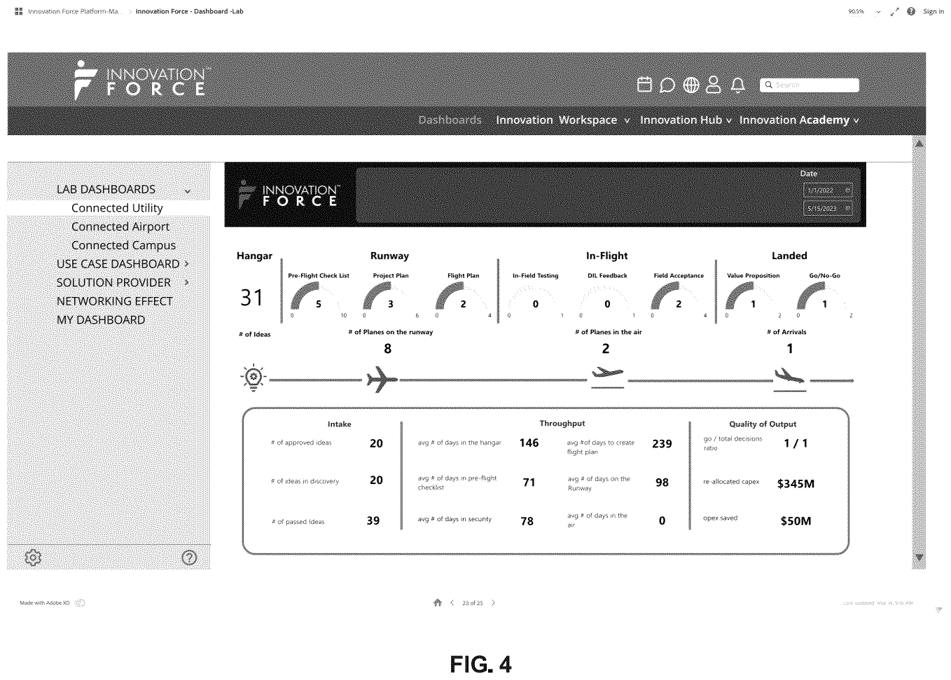

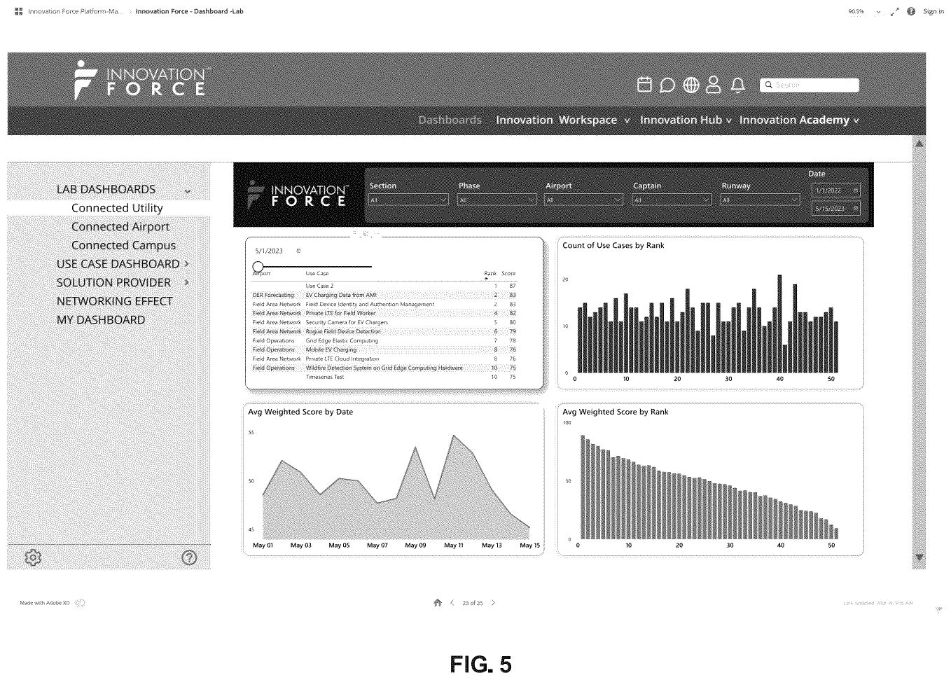

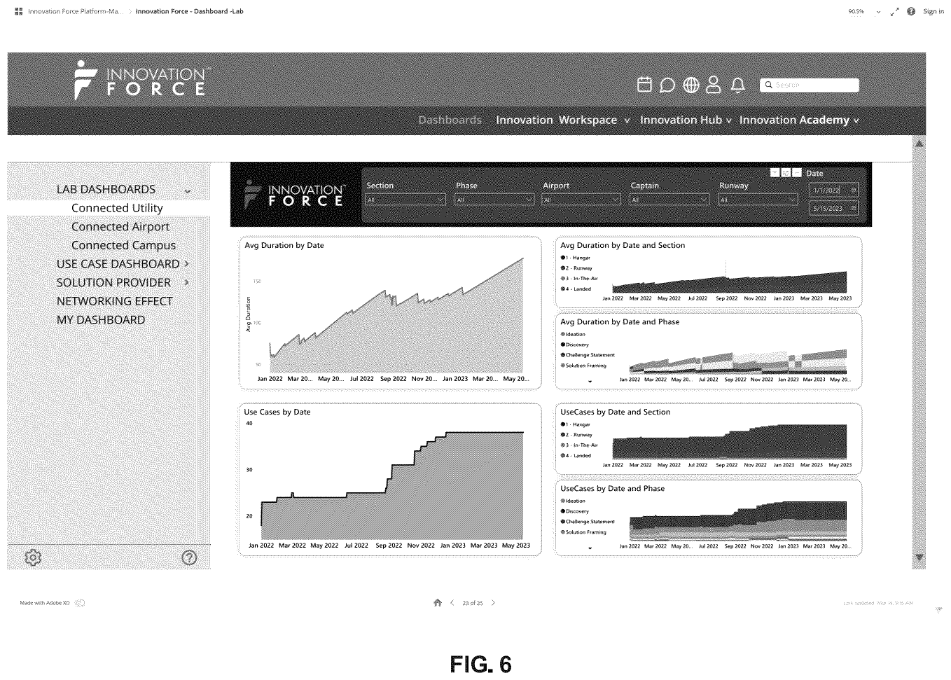

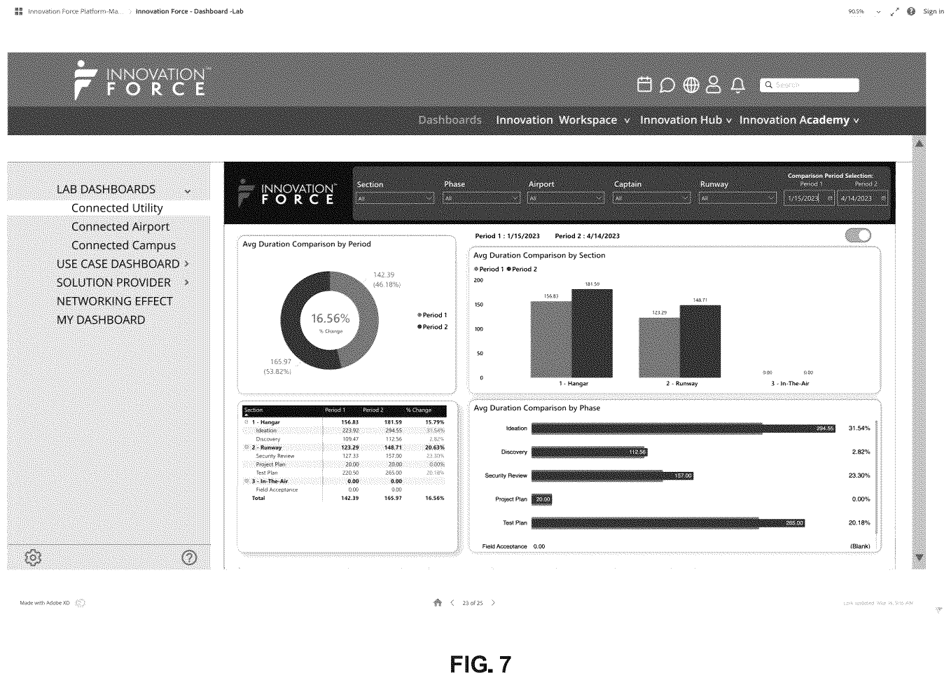

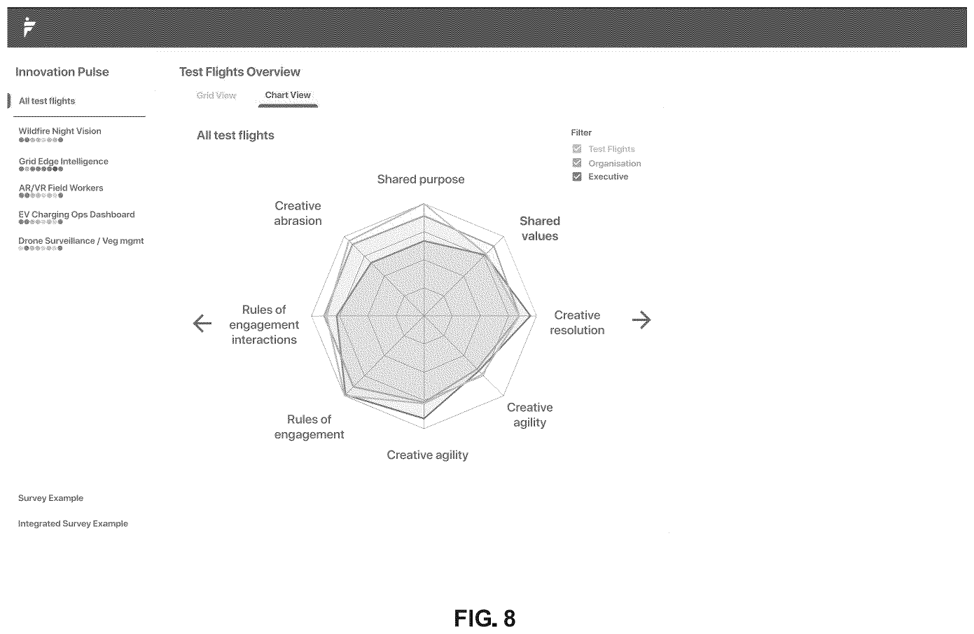

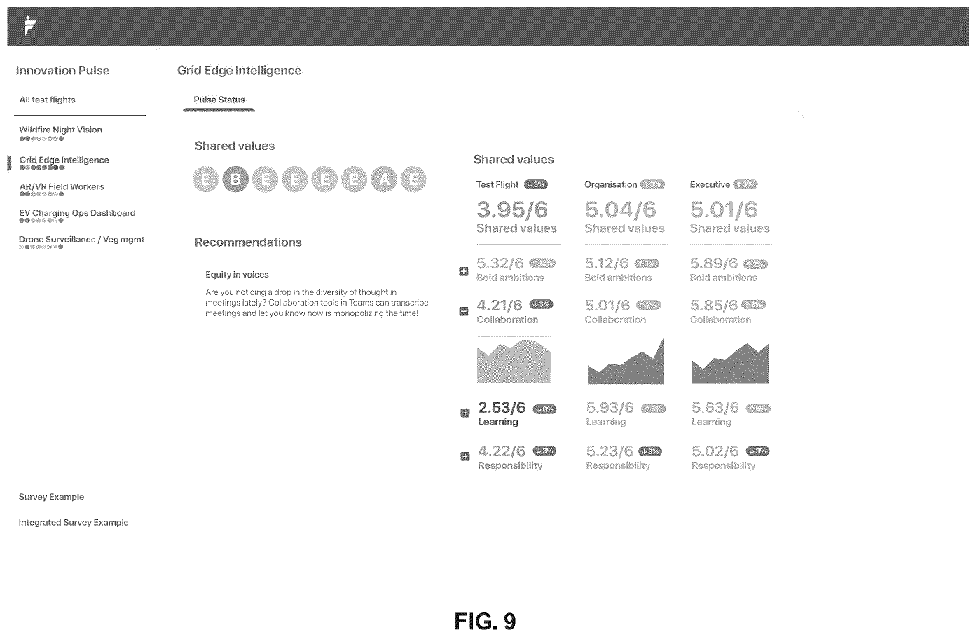

The platform may also provide a minimum of a 3 week time horizon to complete this task when recommending new workflows and innovation networks, having learned over time that it will usually take at least 3 weeks. This information may also be provided as a proposed optimization of user-defined workflows, or as a warning to users who provide less than 3 weeks that their anticipated completing timeframe is contrary to empirical data and may be unrealistic. These are non-limiting, exemplary illustrations of how workflow data may be collected and monitored and applied using AI model(s) (108) to optimize new innovation workflows. These and other learnings may also be automatically stored in a knowledge management database (107) accessible to the users for searching. A generative AI (108) may also be used to automatically produce human-readable reports written in normal business language which summarize the learnings and conclusions and the data inputs on which they are based. Data insights may be captured through these measurable and repeatable processes and visualized in dashboards. Exemplary embodiments of such dashboards are shown in FIGS. 1-9.

An innovation platform as described herein may include the ability for individual users and/or enterprises or organizations to create and manage accounts and profiles associated with one or more nodes (103). These profiles may be based on defined roles they play on an innovation team, and within the innovation process/workflows, and to establish or provide access to additional information or data about the skills, credentials, competencies, capabilities, and availability of the resource associated with the node(s) (103) in question. In an embodiment, cost or budget information may be associated with a node (103) to reflect the expense associated with node (103) utilization. This data may be used for budget management and cost projection. In an embodiment, this data could be used for expense sharing and reconciliation where a plurality of enterprises are collaborating through the network.

The platform may include the ability to create innovation workflows or design innovation programs using innovation workflows recommended by the platform's AI (108) based on prior learnings. The platform may be provided with an industry, field, or other use case or context, and may query its catalog of inputs to find successful innovation workflows aligned to the use case. Other data inputs may also be provided to further narrow the output, such as a minimum or maximum number of nodes (103), inventory of available skills, credentials, competencies, capabilities, and availabilities, an associated minimum or maximum budget, desired minimum or maximum timeframes, and overall strategic outputs.

In an embodiment, the platform provides the ability to create or design, or to get recommendations from the AI model (108) on the structure and competition of innovation teams comprising a plurality of nodes (103) to achieve a particular result. By way of example and not limitation, suppose a researcher desired to create a virtual “lab” to test a new technology for carbon sequestration. A user may be able to create, or ask the AI model (108) to create, an innovation team with the requisite characteristics (e.g., skills, credentials, competencies, capabilities, availabilities, costs, etc.) to carry out the work. The user may not even know which characteristics are needed, or in what quantities, and may instead rely on the AI model (108) to generate recommendations based on the composition of prior successful teams for that context or use case, or similar contexts or use cases.

In this fashion, the platform may be used not only to develop the structure of such a team, but to provide realistic cost estimates that can be used for budgeting, which in turn may help to ensure that new innovation initiatives have realistic budgets. This is particularly important when applying for grants and other outside funding, as it improves the likelihood that all required skills and associated costs are accounted for. This feature could be further used to actually assemble one or more teams from the available nodes (103) in the platform. Individual nodes (103) can signal their availability for work in various contexts (or any context or use case) and thus could be invited to join a new innovation team.

In an embodiment, individual nodes (103) may also be scored or otherwise have success profile indicators that can be reviewed by a designer to determine the node's (103) suitability for inclusion in a given team. Similarly, the AI model (108) may also take such ratings into account when recommending team members (e.g., if a node (103) with “geospatial” expertise is frequently rated highly for natural disaster and emergency response contexts, but less so for land use contexts, that node (103) may be less preferred for projects with contexts related to land use, such as urban planning).

In an embodiment, the platform may have social networking aspects, wherein individual nodes (103) can “friend” and “follow” each other to monitor and learn about project work being done by each other, and to provide networking contacts and opportunities for developing future collaboration relationships. The platform may also include conventional features for collaboration platforms, such as meeting scheduling, calendar syncing, reminders, and so forth.

In an embodiment, the platform comprises a guided workflows feature and form builders which provides a GUI manipulable by users to complete innovation processes in a structured, multi-step fashion. Common elements of such a process include problem formulation (including identification of success and test criteria), solution framing (how to solve), field trials (how to test and capture day in the life learnings from the field trial), business case creation, and go/no-go decision to move use cases into production-ready environments.

In an embodiment, the platform may comprise the ability to receive, store, and share documents into a knowledge management database (107) to represent project plans, test plans and day in the life reports learnings captured in the process. This document repository may be sharable in whole or part across organizations, with security permissions as needed to share content to approved list of nodes (103) and, if desired, not the public.

In an embodiment, the platform may comprise the ability to track and report key performance indicators visualized in dashboards built for various views associated to node (103) roles. KPIs are based on data gathered by measuring and conducting statistical analysis of the various aspects of the workflows. Further, the platform may comprise data capture throughout a platform to enable future development, including machine learning and predictive analysis, and conduct behavior data captured throughout the process to help measure team engagement and psychological safety, diversity and networking effects created in the innovation process.

The platform analyzes custom innovation workflows and human engagement to optimize innovation execution contextually at the intersection of science and human behavior. This platform will detect the context of the innovation being executed, such as a product or process, across any industry to offer rapid insights and recommended actions to minimize or avoid delays while maximizing innovation output quality.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

What is claimed is:

1. One or more non-transitory computer-readable storage media storing one or more programs, said one or more programs comprising instructions, which when executed by one or more processors of one or more server computers, cause said one or more server computers to:
receive, via a telecommunication network, a plurality of requests to create an innovation node for an associated resource, each of said requests comprising resource characteristic data for said associated resource;
create, for each request of said plurality of received requests, profile data for said associated resource, said profile data comprising at least some of said resource characteristic data for said associated resource;
receive, via a graphical user interface rendered to a client computer via said telecommunication network, instructions to create a first innovation process workflow associated with an innovation context identifier;
create said innovation process workflow in accordance with said received instructions, said innovation process workflow comprising a plurality of steps, each step of said plurality of steps comprising at least one task assigned to at least one innovation node in said plurality of innovation nodes;
receive, via said telecommunications network, a plurality of datagrams each indicating that at least one of said tasks is complete, said plurality of datagrams collectively indicating that all of said tasks are complete;
receive, via said telecommunications network, evaluation data for said completed innovation process workflow;
generate a training data set for an artificial intelligence model based at least in part on said evaluation data and said completed innovation process workflow; and
using said training data set, train at least one artificial intelligence model to generate innovation process workflows for said innovation context.

2. The one or more non-transitory computer-readable storage media of claim 1, wherein said resource characteristic data comprises one or more characteristics selected from the group consisting of: type, privilege, credentials, license, cost, qualifications, skills, industry/field, and availability.

3. The one or more non-transitory computer-readable storage media of claim 2, wherein said associated resource is selected from the group consisting of: a person, an organization, a computer system, a data source, and a process.

4. The one or more non-transitory computer-readable storage media of claim 3, wherein a first innovation node of said plurality of innovation nodes comprises an administrative node.

5. The one or more non-transitory computer-readable storage media of claim 4, wherein said created innovation process workflow further comprises, for at least some steps in said plurality of steps, an identification of at least one input to said step and an identification of at least one output from said step.

6. The one or more non-transitory computer-readable storage media of claim 5, wherein said evaluation data is received from a client computer associated with said administrative node.

7. The one or more non-transitory computer-readable storage media of claim 6, wherein said instructions, when executed by said one or more processors of said one or more server computers, further cause said one or more said computers to:
receive user input data from a client computer via said telecommunications network, said user input data comprising information about a desired innovation process workflow; and
create, using said trained at least one artificial intelligence model, an innovation process workflow based on said received user input data.

8. The one or more non-transitory computer-readable storage media of claim 7, wherein said instructions, when executed by said one or more processors of said one or more computers, further cause said one or more computers to:
predict, using said trained at least one artificial intelligence model, a cost budget for said innovation process workflow created using said using said trained at least one artificial intelligence model.

9. The one or more non-transitory computer-readable storage media of claim 8, wherein said instructions, when executed by said one or more processors of said one or more computers, further cause said one or more computers to optimize an innovation process workflow using said training at least one artificial intelligence model.

10. The one or more non-transitory computer-readable storage media of claim 9, wherein said optimization comprises reassigning a first task to a different innovation node.

11. A method comprising:
receiving, via a telecommunication network, a plurality of requests to create an innovation node for an associated resource, each of said requests comprising resource characteristic data for said associated resource;
creating, for each request of said plurality of received requests, profile data for said associated resource, said profile data comprising at least some of said resource characteristic data for said associated resource;
receiving, via a graphical user interface rendered to a client computer via said telecommunication network, instructions to create a first innovation process workflow associated with an innovation context identifier;
creating said innovation process workflow in accordance with said received instructions, said innovation process workflow comprising a plurality of steps, each step of said plurality of steps comprising at least one task assigned to at least one innovation node in said plurality of innovation nodes;
receiving, via said telecommunications network, a plurality of datagrams each indicating that at least one of said tasks is complete, said plurality of datagrams collectively indicating that all of said tasks are complete;
receiving, via said telecommunications network, evaluation data for said completed innovation process workflow;
generating a training data set for an artificial intelligence model based at least in part on said evaluation data and said completed innovation process workflow; and
using said training data set, training at least one artificial intelligence model to generate innovation process workflows for said innovation context.

12. The method of claim 11, wherein said resource characteristic data comprises one or more characteristics selected from the group consisting of: type, privilege, credentials, license, cost, qualifications, skills, industry/field, and availability.

13. The method of claim 12, wherein said associated resource is selected from the group consisting of: a person, an organization, a computer system, a data source, and a process.

14. The method of claim 13, wherein a first innovation node of said plurality of innovation nodes comprises an administrative node.

15. The method of claim 14, wherein said created innovation process workflow further comprises, for at least some steps in said plurality of steps, an identification of at least one input to said step and an identification of at least one output from said step.

16. The method of claim 15, wherein said evaluation data is received from a client computer associated with said administrative node.

17. The method of claim 16, further comprising:
receiving user input data from a client computer via said telecommunications network, said user input data comprising information about a desired innovation process workflow; and
creating, using said trained at least one artificial intelligence model, an innovation process workflow based on said received user input data.

18. The method of claim 17, further comprising:
predicting, using said trained at least one artificial intelligence model, a cost budget for said
innovation process workflow created using said using said trained at least one artificial intelligence model.

19. The method of claim 18, further comprising:
optimizing an innovation process workflow using said training at least one artificial intelligence model.

20. The method of claim 19, wherein said optimization comprises reassigning a first task to a different innovation node.
